(19) United States
(12) Patent Application Publication
(10) Pub. No.: US 2016/0137153 A1
(43) Pub. Date: May 19, 2016

(54) AIRBAG DEPLOYMENT METHOD

(71) Applicant: Hyundai Mobis Co., Ltd., Seoul (KR)

(72) Inventor: Gun Woo KIM, Yongin-si (KR)

(21) Appl. No.: 14/621,113

(22) Filed: Feb. 12, 2015

(30) Foreign Application Priority Data
Nov. 17, 2014 (KR) 10-2014-0160029

(51) Int. Cl. B60R 21/015; B60R 21/231

(52) U.S. Cl. CPC B60R 21/01512; B60R 21/231; B60R 2021/23107

(57) ABSTRACT

An airbag deployment method for a vehicle including a dual-stage inflator, the method including sensing a vehicle collision; sensing whether a passenger seated in a seat of the vehicle is a child or an adult; and deploying an airbag using the inflator depending on the sensed type of passenger. The inflator includes a low-pressure first chamber and a high-pressure second chamber. If the sensed passenger is a child, the low-pressure first chamber is initially activated. If the sensed passenger is an adult, the high-pressure second chamber is initially activated.

### CROSS-REFERENCE TO RELATED APPLICATION

This application claims priority to and the benefit of Korean Patent Application No. 10-2014-0160029, filed on Nov. 17, 2014, which is hereby incorporated by reference for all purposes as if fully set forth herein.

### BACKGROUND

1. Field

Exemplary embodiments relate to an airbag deployment method. More particularly, exemplary embodiments relate to an airbag deployment method capable of setting a pressure for each chamber of an inflator, which is applied to a dual-stage airbag, and changing an airbag deployment condition

2. Discussion of the Background

Generally, an airbag that is equipped in a vehicle is protective equipment used to effectively reduce serious injury to a human body. The airbag serves as a cushion by being expanded at the time of a vehicle collision to absorb kinetic energy of a passenger while slowly decelerating the passenger, thereby serving to protect the passenger from the vehicle collision. To this end, the airbag needs to be expanded at a set position as rapid as possible, toward a front surface of the passenger at the time of the vehicle collision. However, when a child, who does not often wear a seat belt is sitting at an abnormal position, the rapid expansion may seriously injure the child.

Therefore, to control an expansion speed of the airbag depending on whether a passenger is a child or an adult, a dual-stage inflator (or dual-stage type inflator) is used.

FIG. 1 is a diagram illustrating a configuration of a dual-stage inflator.

Referring to FIG. 1, a dual-stage inflator 1 includes a first chamber 2 and a second chamber 3 having gas generating agents 6 embedded therein, based on a partition 4 at a center thereof and partition walls 5 at both ends thereof and are partitioned at a predetermined ratio. Explosives 7 disposed at outer sides of the partition walls 6 at both ends of the first chamber 2 and the second chamber 3 are exploded depending on an ignition signal transferred from an electronic control unit (ECU), and an ignition charge 8 which is supplied to the first chamber 2 and the second chamber 3 while being exploded by these explosives 7. The supplied ignition charge 8 combusts the gas generating agents 6 which are embedded in the first chamber 2 and the second chamber 3, respectively, to generate expansion gas, which is then introduced into an airbag cushion (not shown) through a hole 9.

The inflator 1 having the above structure may generate two types of outputs. That is, the inflator 1 may generate an output corresponding to the type of passenger. If the passenger is an adult, the first chamber 2 is initially activated, and then the second chamber 3 is activated after a predetermined time lapses. If the passenger is a child, only the first chamber 2 is activated.

The pressure of the first chamber 2 may be reduced in the case of the child passenger, but the first chamber 2 is formed at a high pressure of 60 to 70% of the total pressure of both the first and second chambers, in order to protect a passenger by rapidly deploying a cushion in consideration of collision performance.

The first chamber 2 is formed to develop a high pressure, as described above, and as a result, impact strength of the cushion applied to the child in the state in which the child passenger is abnormally seated becomes high, which is a factor in causing a serious injury. To mitigate the above problem, additional separate structures, such as a “low-risk deployment” (LRD) vent and an active vent, should be included to control the internal pressure of the cushion or reduce an initial pressure by changing deployment of an airbag depending on a passenger. However, installation of such separate structures necessarily incurs added cost and expense.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide an airbag deployment method capable of setting a pressure for each chamber of an inflator that is applied to a dual-stage airbag, and deploying an airbag customized based on whether the passenger is an adult or a child by changing an airbag deployment condition.

Additional aspects will be set forth in the detailed description which follows, and, in part, will be apparent from the disclosure, or may be learned by practice of the inventive concept.

An exemplary embodiment discloses an airbag deployment method for a vehicle including a dual-stage inflator, the method including sensing a vehicle collision; sensing whether a passenger seated in a seat of the vehicle is a child or an adult; and deploying an airbag using the inflator depending on the sensed type of passenger. The inflator includes a low-pressure first chamber and a high-pressure second chamber. If the sensed passenger is a child, the low-pressure first chamber is initially activated.

An exemplary embodiment also discloses an airbag deployment method for a vehicle including a dual-stage inflator, the method including sensing a vehicle collision; sensing whether a passenger seated in a seat of the vehicle is a child or an adult; and deploying an airbag using the inflator depending on the sensed type of passenger. The inflator includes a low-pressure first chamber and a high-pressure second chamber. If the sensed passenger is an adult, the high-pressure second chamber is initially activated.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a diagram illustrating a configuration of a dual-stage inflator.

FIG. 2 is a diagram illustrating an airbag deployment system according to an exemplary embodiment of the present invention.

FIG. 3 is a diagram illustrating a configuration of an airbag module according to the related art.

FIG. 4 is a diagram illustrating a configuration of an airbag module according to an exemplary embodiment of the present invention.

FIG. 5 is a flow chart illustrating an airbag deployment method according to an exemplary embodiment of the present invention.

FIG. 6 is a comparison graph of a pressure of the inflator when the airbag according to the exemplary embodiment of the present invention is deployed.

FIG. 7 is a graph illustrating a change in an internal pressure of a cushion when the airbag according to the exemplary embodiment of the present invention is deployed.

### DETAILED DESCRIPTION OF THE ILLUSTRATED EMBODIMENTS

Hereinafter, an airbag deployment method according to an exemplary embodiment of the present invention will be described in detail with reference to the accompanying drawings. It is to be noted that in giving reference numerals to components of each of the accompanying drawing, like reference numerals refer to like components even though the like components are shown in different drawings. Although exemplary embodiments of the present invention will be described below, the scope of the present invention is not limited thereto, but may be variously modified by those skilled in the art. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

FIG. 2 is a diagram illustrating an airbag deployment system according to an exemplary embodiment of the present invention.

Referring to FIG. 2, the airbag deployment system according to the exemplary embodiment of the present invention includes a collision sensing sensor 10, a passenger sensing system 20, a control engine control unit (ECU) 30, and an airbag 40.

The collision sensing sensor 10 senses a vehicle collision and transfers a collision signal to the control ECU 30 to deploy the airbag 40.

The passenger sensing system 20 may identify a type of passenger that is seated in an auxiliary seat. The passenger sensing system 20 may differentiate whether a passenger who is seated in the auxiliary seat is an adult or a child. According to an exemplary embodiment of the present invention, the passenger sensing system 20 may differentiate a passenger using a weight measured by a weight sensor which is installed at a seat of a vehicle. A sensing apparatus of a seat belt may differentiate whether a passenger wears a seat belt or does not wear the seat belt.

When the control ECU 30 receives a collision signal of a vehicle from the collision sensing sensor 10, the control ECU 30 determines a type of passenger using the passenger sensing system 20 to instruct deployment of an airbag. In this case, the control ECU 30 instructs airbag deployment logic by differentiating whether the passenger is an adult or a child.

The airbag 40 receives the instruction of the control ECU 30 to sequentially activate a low-pressure first chamber and a high-pressure second chamber.

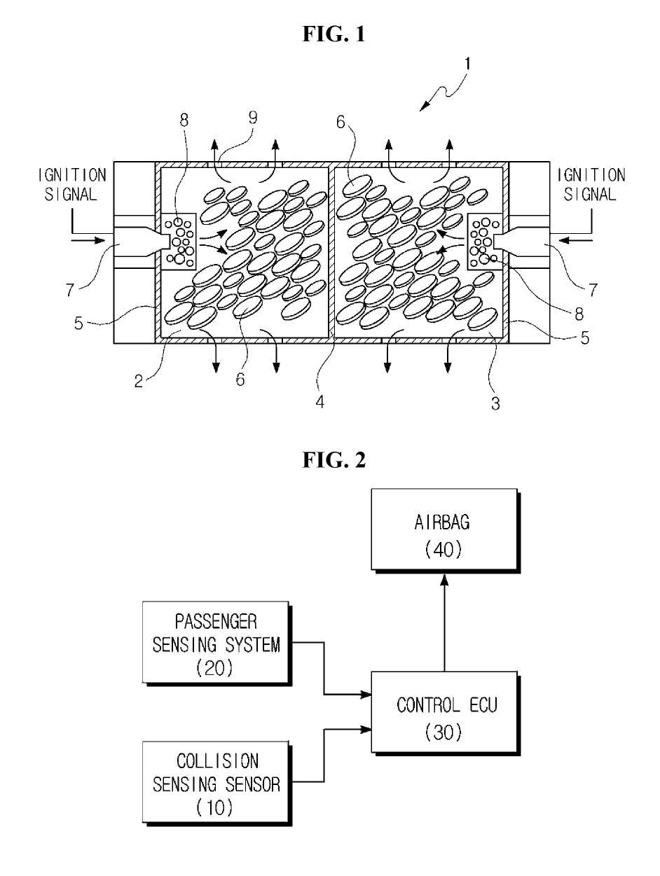

Referring to FIG. 1, in the airbag, a dual-stage inflator 1 includes a first chamber 2 and a second chamber 3 having gas generating agents 6 embedded therein. A partition 4 is disposed at a center thereof, and partition walls 5 are disposed at both ends of the inflator. The first and second chambers 2, 3 are partitioned at a predetermined ratio. Explosives 7 are disposed at outer sides of the partition walls 6 at both ends of the first chamber 2 and the second chamber 3, and are exploded depending on an ignition signal transferred from an ECU. An ignition charge 8 supplied to the first chamber 2 and the second chamber 3 is exploded by these explosives 7. In this case, unlike a driving condition of the dual-stage inflator 1 of the related art, the first chamber 2 is configured to be at a low pressure, and the second chamber 3 is configured to be at a high pressure.

The supplied ignition charge 8 combusts the gas generating agents 6 that are embedded in the first chamber 2 and the second chamber 3, respectively, to generate expansion gas, which is then introduced into an airbag cushion through a hole 9.

As such, in the case of setting the pressure for each chamber of the inflator 1 of the related art, a high pressure is formed in the first chamber 2 and a low pressure is formed in the second chamber 3, but in the airbag system according to the exemplary embodiment of the present invention, a low pressure is formed in the first chamber 2 and a high pressure is formed in the second chamber 3.

The control ECU 30 first activates the low-pressure first chamber 2 to reduce impact strength when the child passenger collides with the airbag cushion, in the case in which the passenger is a child, and first activates the high-pressure second chamber 3 to protect the adult passenger by rapidly deploying the airbag, in the case in which the passenger is an adult.

In the case of setting the pressure as described above, when the passenger is sensed as a child by the passenger sensing system 20, the first chamber 2 is activated like the existing airbag system and a pressure lower than the existing pressure is generated. Therefore, various additional apparatuses used in the related art, which are required to prevent an injury to a child passenger, may be omitted.

When the passenger is sensed as an adult by the passenger sensing system 20, the system is changed so that the high-pressure second chamber 3 is initially activated instead of the low-pressure first chamber 2. The high-pressure second chamber 3 is activated, and thus, the high pressure is formed in the cushion at an initial rapid time to restrict the adult passenger, thereby effectively protecting the passenger from the vehicle collision.

The setting of the pressure of the first chamber 2 and the pressure of the second chamber 3 is determined depending on vehicle performance, but the pressure of the first chamber 2 is set to be lower than that of the second chamber 3. The pressure of the first chamber 2 may be variously set within a range of 10 to 25% of the full pressure of the cushion of the airbag 1; the pressure of the second chamber 3 may be variously set within a range of 75 to 90% of the full pressure of the cushion of the airbag 1; and a sum of the pressure of the first chamber 2 and the pressure of the second chamber 3 may be set to be the full pressure of the cushion of the airbag 1.

According to the exemplary embodiment of the present invention, the setting of the pressure of the first chamber 2 and the pressure of the second chamber 3 may be formed as indicated in the following Table 1.

TABLE 1

| Specification | Full Pressure | First Chamber | Second Chamber |
|---|---|---|---|
| Specification 1 | 100% | 10% | 90% |
| Specification 2 | 100% | 20% | 80% |
| Specification 3 | 100% | 25% | 75% |

However, in the present invention, the pressures of the chambers are not limited to the above examples. Therefore, the first chamber 2 may be variously changed to have a lower pressure than that of the second chamber 3.

The airbag deployment system in accordance with the exemplary embodiment of the present invention may change the pressure of the chamber and the deployment system while using the structure of the existing dual-stage inflator 1 to solve the existing problems noted above.

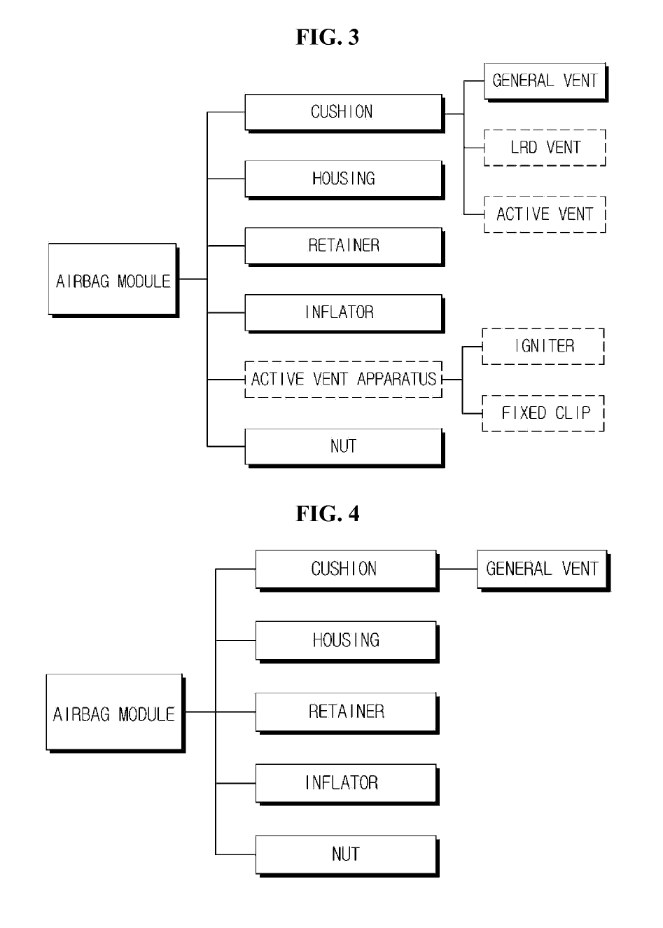

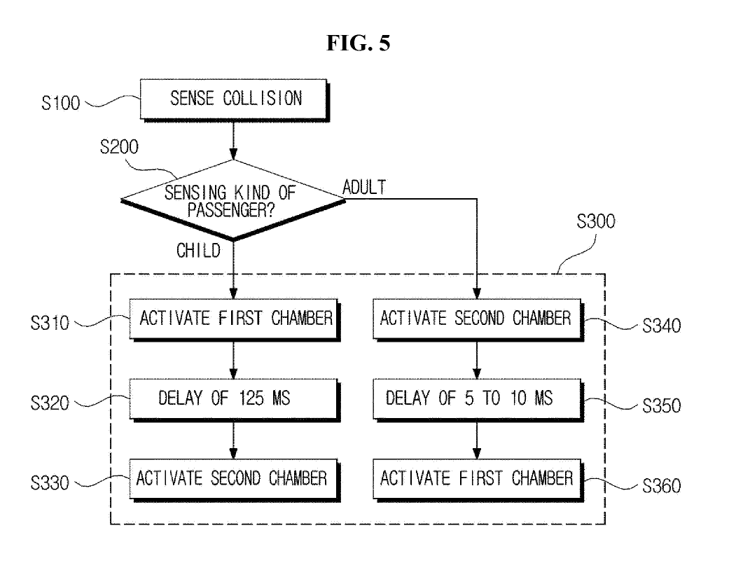

FIG. 3 is a diagram illustrating a configuration of an airbag module according to the related art, and FIG. 4 is a diagram illustrating a configuration of an airbag module according to an exemplary embodiment of the present invention.

Referring to FIGS. 3 and 4, the existing airbag module includes the separate apparatus, such as an active vent and a low risk deployment (LRD) vent to prevent an injury to a child passenger due to the collision with the airbag cushion when the first chamber formed at the high pressure is activated.

Referring to FIG. 3, the existing airbag module includes a cushion, a housing, a retainer, an inflator, an active vent apparatus, and a nut, in which the cushion includes a general vent, the LRD vent, and the active vent and the active vent apparatus includes a separate igniter and a fixed clip.

However, as illustrated in FIG. 4, according to the airbag deployment method in accordance with the exemplary embodiment of the present invention, the LRD vent and the active vent may be omitted, and the igniter and the fixed clip, which are additional components for mounting the active vent apparatus, may be omitted, thereby obtaining effects such as cost saving, the reduction in the number of processes, and the like.

Meanwhile, the airbag deployment method according to the exemplary embodiment of the present invention will be described below with reference to the accompanying drawings. However, the description of the same components as those described in the airbag deployment system will be omitted.

FIG. 5 is a flow chart illustrating the airbag deployment method according to an exemplary embodiment of the present invention. In FIG. 5, the same reference numerals as FIGS. 1 to 4 represent the same members, and the detailed description thereof will be omitted.

Referring to FIG. 5, the airbag deployment method according to the exemplary embodiment of the present invention may include sensing a collision (S100), sensing a kind of passenger (S200), and deploying an airbag (S300).

In sensing the collision (S100), the vehicle collision may be recognized. In sensing of the collision (S100), various types of collision recognition sensors, or a collision recognition apparatus may be used.

In the sensing of the kind of passenger (S200), when the vehicle collision is sensed (S100), a kind of passenger that is seated in a seat may be determined. According to the exemplary embodiment of the present invention, the kind of passenger may be divided into an adult and an infant. The division of the kind of passenger is only an example, and therefore, the kind of passenger may also be more subdivided.

In the sensing of the kind of passenger (S200), the passenger sensing method may use a weight sensor, and the like, which is installed at a seat, and may be variously changed within the technical scope of differentiating the kind of passenger that is sensed.

In the deploying of the airbag (S300), the airbag is deployed by the control ECU 30; the control ECU 30 receives a kind of passenger sensed during the sensing of the kind of passenger (S200); and the airbag deployment logic is changed depending on the kind of passenger sensed in order to deploy the airbag.

When the kind of passenger sensed is a child, the low-pressure first chamber 2 is activated (S310). The low-pressure first chamber 2 is initially activated. Thus, the LRD performance may be satisfied only by the formation of the low pressure without the additional apparatus, such as the LRD vent, which is installed in the existing airbag cushion. In this case, the first chamber 2 may be set to have a low pressure of 10 to 25% of the total pressure of the first and second chambers 2, 3.

The low-pressure first chamber 2 is activated (S310), and then the high-pressure second chamber 3 is activated (S330). A delay of a predetermined time is present between the activation of the first chamber 2 and the activation of the second chamber 3 (S320). According to the exemplary embodiment of the present invention, the delay time may be set to be 125 ms, which may be changed depending on a kind of vehicle.

The reason why the first chamber is activated (S310) and then has the delay of the predetermined time is to solve the handling problem of the explosives 7, and the like, which may occur when the first chamber is not activated, which is independent of the airbag performance. Therefore, after the delay of the predetermined time, the second chamber 3 is activated.

If it is determined that the passenger is an adult, the high-pressure second chamber 3 is initially activated (S340). The pressure of the first chamber 2 is set to be low, and thus, the pressure of the second chamber 3 may be increased. In this case, the second chamber may be set to be at a pressure of 75 to 90% of the total pressure of the first and second chambers 2, 3.

As the pressure of the second chamber 3 is set to be high at an early stage, the pressure is more rapidly formed in the cushion than the existing pressure to expand the cushion, thereby more rapidly restricting the passenger than in the related art.

The second chamber 3 is initially activated, and then the low-pressure first chamber is activated (S360). The delay of the predetermined time is present between the activation of the second chamber 3 and the activation of the first chamber 2 (S350). In this case, the occurring delay time is generated in the airbag deployment logic. According to the exemplary embodiment of the present invention, the delay time may be set as an operation time of 5 to 10 ms, and may be changed depending on characteristics of the deployment logic.

The pressure formed in the cushion by the rapid activation of the second chamber 3 exits through the vent hole, and thus, the pressure of the cushion is reduced. In this case, the low-pressure first chamber 2 is deployed to support a passenger and thus may have the same effect as the active vent, which is mounted to reduce the high pressure that is formed at a latter half portion of the existing airbag deployment.

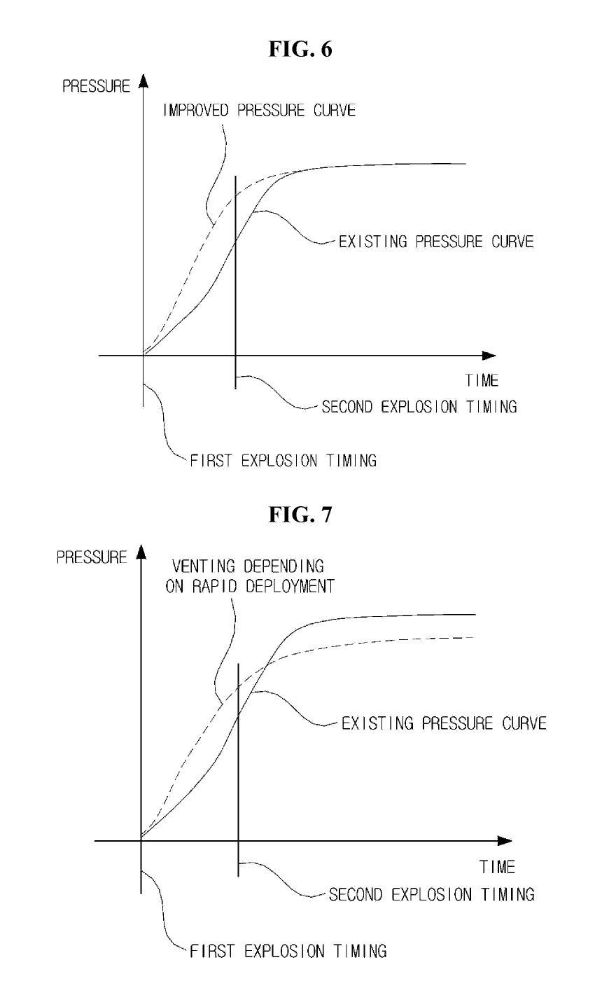

FIG. 6 is a comparison graph of a pressure of the inflator when the airbag according to the exemplary embodiment of the present invention is deployed, and FIG. 7 is a graph illustrating a change in an internal pressure of a cushion when the airbag according to the exemplary embodiment of the present invention is deployed.

Referring to FIG. 6, in the case of the adult collision, the pressure change depending on the explosion of explosives within the inflator of the first chamber 2 and the second chamber 3 may be compared. Compared with the existing pressure curve, the higher pressure is formed at an earlier stage than in the related art, when the high-pressure second chamber 3 is activated, A sum of all the pressures is maintained when the low-pressure first chamber 2 is activated.

Referring to FIG. 7, in the case of the adult collision, the high-pressure second chamber 3 is first activated, and thus, the internal pressure of the cushion is rapidly increased at an early stage and the venting is performed at an early stage by the rapid activation. Next, it the inflator of the low-pressure first chamber 2 is secondarily exploded, and thus, the internal pressure of the cushion is formed to be lower than the related art.

As described above, the airbag deployment method in accordance with the exemplary embodiment of the present invention may satisfy the low pressure condition which is equal to or less than 50% of the highest pressure which is the optimal pressure condition in the airbag deployment, in the case of the child collision.

The airbag deployment method satisfies the initial high pressure condition (70% or more of the highest pressure) to rapidly protect a passenger and reduce the internal pressure of the cushion of the latter half portion by the venting beforehand and satisfies the low pressure condition (30% or less of the highest pressure) of the latter half portion to continuously restrict the passenger of the latter half portion, in the case of when the adult collision, thereby preventing the injury due to the cushion.

According to the airbag deployment method in accordance with the exemplary embodiments of the present invention, it is possible to deploy the airbag customized for the passenger without installing the separate structure such as the LRD vent and the active vent.

It is possible to reduce the weight and simplify the process by removing the separate structure.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

1. An airbag deployment method for a vehicle comprising a dual-stage inflator, the method comprising:
sensing a vehicle collision;
sensing whether a passenger that is seated in a seat of the vehicle is a child or an adult; and
deploying an airbag using the inflator depending on the sensed passenger,
wherein:
the inflator comprises a low-pressure first chamber and a high-pressure second chamber; and
if the sensed passenger is a child, the low-pressure first chamber is initially activated, and the high-pressure second chamber is activated when a preset delay time elapses after the activation of the low-pressure first chamber.

2. The airbag deployment method of claim 1, wherein the low-pressure first chamber has a pressure of 10 to 25% of a total pressure of the low-pressure first chamber and the high-pressure second chamber.

3. (canceled)

4. The airbag deployment method of claim 1, wherein the delay time is 125 ms.

5. An airbag deployment method for a vehicle comprising a dual-stage inflator, the method comprising:
sensing a vehicle collision;
sensing whether a passenger that is seated in a seat of the vehicle is a child or an adult; and
deploying an airbag using the inflator depending on the sensed passenger,
wherein:
the inflator comprises a low-pressure first chamber and a high-pressure second chamber; and
if the sensed passenger is an adult, the high-pressure second chamber is initially activated, and the low-pressure first chamber is activated when a preset delay time elapses after the activation of the high-pressure second chamber.

6. The airbag deployment method of claim 5, wherein the high-pressure second chamber has a pressure of 75 to 90% of a total pressure of the low-pressure first chamber and the high-pressure second chamber.

7. (canceled)

8. The airbag deployment method of claim 5, wherein the first chamber has a pressure of 10 to 25% of a total pressure of the low-pressure first chamber and the high-pressure second chamber.

9. The airbag deployment method of claim 5, wherein the delay time is 5 to 10 ms.
